(19) United States
(12) Patent Application Publication
(10) Pub. No.: US 2007/0098225 A1
(43) Pub. Date: May 3, 2007

(54) Age verification method for website access

(76) Inventors: Gregory A. Piccionelli, Westlake Village, CA (US); Michael M. Gerardi, Menifee, CA (US)

Correspondence Address: Michael M. Gerardi, 28876 Woodcrest Lake Drive, Menifee, CA, 92584, US

(21) Appl. No.: 11/585,770

(22) Filed: Oct. 23, 2006

Related U.S. Application Data
(60) Provisional application No. 60/731,652, filed on Oct. 28, 2005.

(51) Int. Cl. G06K 9/00

(52) U.S. Cl. 382/115; 726/3; 340/5.53

(57) ABSTRACT

A method of verifying the age of a user desiring to access an age-controlled website includes the steps of: providing a live image of a user to an age-verification site; providing an image of an identification document to the age-verification site, the identification document including an image of a person; determining whether the person depicted in the image in the identification document is the same as the user depicted in the live image and meets an age requirement of an age-controlled website; and enabling the user to access the age-controlled website when the foregoing determination is positive.

This application is based on U.S. Provisional Patent Application Ser. No. 60/731,652, filed Oct. 28, 2005, the entire disclosure of which is incorporated herein by reference.

### FIELD OF THE INVENTION

The present invention relates to methods for verifying the age of a person attempting to access a site on a network, in particular an age-controlled website on a wide-area network such as the Internet.

### BACKGROUND OF THE INVENTION

Many websites on networks, particularly wide-area networks such as the Internet, include subject matter which is intended for viewing by users over a certain age, for example age 18. Such “age-controlled” websites typically display content of an adult nature, such as gambling, liquor or tobacco sales, adult entertainment and the like.

Restricting access to such sites to users who meet the pertinent age requirement has proven problematic. In particular, it has proven difficult to verify that a user claiming to meet the age requirement in fact is of the age claimed. Use of false identification, or submission of false declarations of adult status, can thwart many age-verification procedures.

A need exists for methods which can reliably verify the age of a user attempting to access an age-restricted website.

### SUMMARY OF THE PREFERRED EMBODIMENTS

In accordance with one aspect of the present invention, there is provided a method of verifying the age of a user desiring to access an age-controlled website. The method includes the steps of: providing a live image of a user to an age-verification site; providing an image of an identification document to the age-verification site, the identification document including an image of a person; determining whether the person depicted in the image in the identification document is the same as the user depicted in the live image and meets an age requirement of an age-controlled website; and enabling the user to access the age-controlled website when the foregoing determination is positive.

In specific embodiments, the live image is provided by a video camera, more particularly a video camera that is incorporated in a picture phone. The image of the identification document is also provided by a video camera in other specific embodiments.

According to further embodiments, the image of the identification document is provided by scanning the document to produced a scanned image and transmitting the scanned image. Alternatively, the image of the identification document is provided to the user by the identification document's issuing authority, and the user transmits the image so provided to the age-verification site.

In particular embodiments, the determination step is performed by an age-verification agent.

Once a positive determination has been made, the user is provided, in specific embodiments, with an access code enabling access to the age-controlled website.

Other features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flowchart illustrating a method according to the invention,

FIG. 2 is an illustration of a first embodiment of a method according to the invention in which a user transmits to an age-verification site an image of himself, as well as of an identification document (e.g., a driver's license) using a video camera, and

FIG. 3 is an illustration of an alternative embodiment in which the user transmits an image of himself and of a driver's license to the age-verification site using a camera phone.

Like numerals refer to like parts throughout the several views of the drawings.

### DETAILED DESCRIPTION OF THE PREFERRED EMBODIMENTS

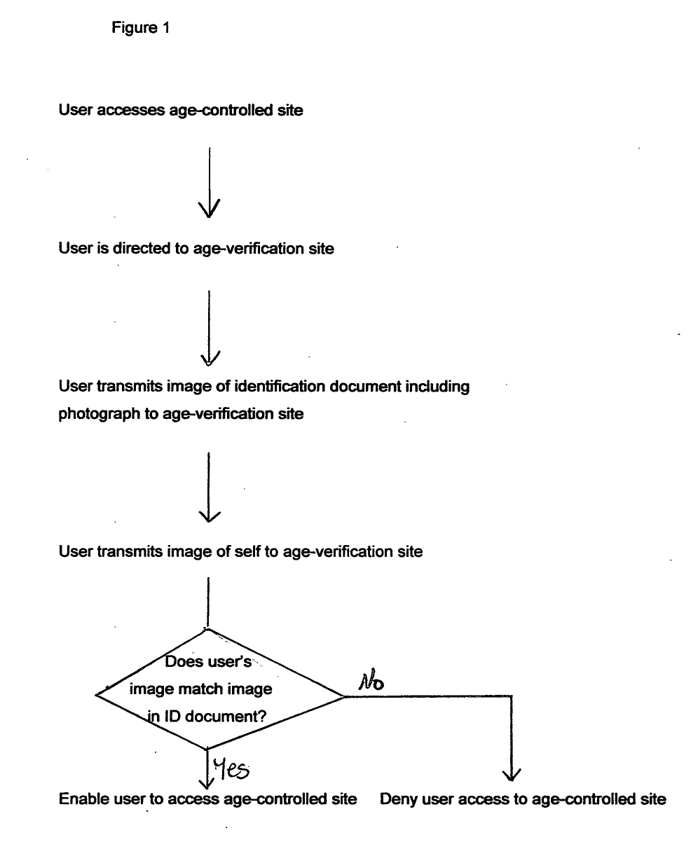

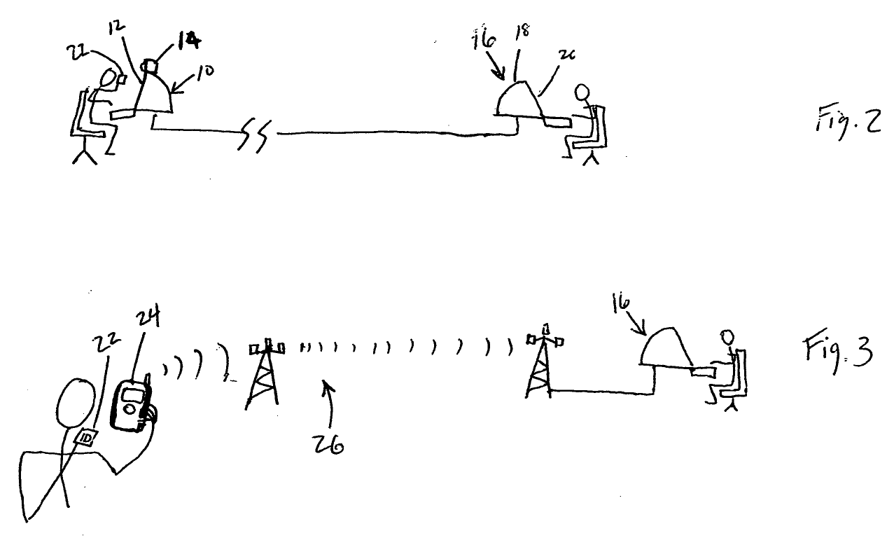

Turning now to the drawings, FIG. 1 describes a general method according to the invention. A first specific embodiment of the inventive method is shown in FIG. 2. A user initially attempts to access an age-controlled website using computer 10 equipped with monitor 12 and video camera 14. The website directs the user to an age-verification site manned by an age-verification agent at station 16 including a computer 18 with monitor 20. The user is instructed to present an identification document 22, such as a driver's license or other document as may be prescribed by law or otherwise, which includes an image, such as a photograph or other visual depiction, of the user. The user then displays the identification document before video camera 14, and the image of the identification document is then displayed to the age-verification agent via monitor 20. The user then appears before the video camera 14, which transmits a live image of the user to the age-verification agent. The age-verification agent next compares the live image of the user with the image of the user included in identification document 22.

If the age-verification agent determines that the live image of the user and the image included in identification document 22 depict the same person, the age-verification agent then determines if identification document 22 establishes that the user's age meets the age requirement to access the age-controlled website. If the user's age meets the requirement, the user is then authorized to access the age-controlled website.

In addition to providing an image of the identification document via video camera 14, the image can be provided by other means, such as via a scanner, a fax machine, or any other device capable of transmitting an image. In more specific embodiments, the user provides the image via a camera phone 24 (FIG. 3). In such embodiments, the camera phone 24 can replace separate video camera 14 and thus be used to transmit images of both the identification document and of the user over a telecommunications network 26 to age-verification site 16.

According to further embodiments, a previously stored image of the identification document can be transmitted to the age-verification agent. The image can be stored, for example, in the user's computer, or in the user's cell phone, camera phone or other hand-held device. The image can be produced by, for example, scanning the identification document and storing the scanned image, or alternatively, a digitized file containing the image can be provided to the user directly from the identification document's issuing authority, such as a state government. In more specific embodiments, the image so provided is watermarked or otherwise protected against fraudulent use.

As an additional aid to the age-verification software, further embodiments of the invention utilize pattern-recognition software to provide supplemental verification of the identification document. For example, software is provided in certain embodiments that verifies that the format of a driver's license submitted by the user is correct (e.g., that a California driver's license includes the correct identification indicia, such as name, address and age, and that the indicia and the licensee's photograph are positioned properly).

Once the user's age is verified as meeting the age requirement of the age-controlled website, the user is provided, in specific embodiments, with a code allowing access to the age-controlled web site. More specifically, the code can be used to access one or more additional age-controlled web sites whose age requirements the user also satisfies.

According to additional particular embodiments, the user provides a verification statement declaring that the information provided is true and accurate, and submits an electronic signature with the statement. Upon verification of the user's age and receipt of the verified statement, the user is then provided with a code as described above.

In specific embodiments, once the users age is verified, an image of the user's identification document, together with additional information pertaining to the user, such as the above-mentioned access code in additional specific embodiments, is stored in a database, such as a database maintained by the age-verification site. The stored identification document is now available for use in subsequent instances in which the user needs to provide age verification.

In addition to being directed to the age-verification site from an age-controlled website, a user can contact the age-verification site directly, for example via a picture phone as illustrated in FIG. 3. The user can simply call a phone number associated with the age-verification site, then provide an image of an identification document, together with a live image, using the picture phone. At the age-verification site, an age-verification agent determines whether the user's age meets the age requirement of at least one age-controlled website in a manner similar to those described above. When a positive determination is made, the age-verification agent provides the user with an access code enabling the user to access at least one age-controlled website for which the user meets the age requirement.

What is claimed is:

1. A method of verifying the age of a user desiring to access an age-controlled website, the method comprising the steps of:
a) providing a live image of a user to an age-verification site,
b) providing an image of an identification document to the age-verification site, the identification document comprising an image of a person and an indication of the age of the person,
c) determining whether the person depicted in the image in the identification document the same as the user depicted in the live image and meets an age requirement of an age-controlled website, and
d) enabling the user to access the age-controlled website when the determination in step c) is positive.

2. The method of claim 1 wherein the live image is provided by a video camera.

3. The method of claim 2 wherein the video camera is incorporated in a picture phone.

4. The method of claim 1 wherein the image of the identification document is provided by a video camera.

5. The method of claim 1 wherein the image of the identification document is provided by scanning the document to produced a scanned image and transmitting the scanned image.

6. The method of claim 1 wherein the image of the identification document is provided to the user by the identification document's issuing authority.

7. The method of claim 1 wherein step c) is performed by an age-verification agent.

8. The method of claim 1 wherein in step d) the user is provided with an access code enabling access to the age-controlled website.
